(19) United States
(12) Patent Application Publication
(10) Pub. No.: US 2002/0067898 A1
(43) Pub. Date: Jun. 6, 2002

(54) Packaging integrated optical devices

(76) Inventors: Matthew Peter Shaw, Oxford (GB); Paul Ian Talbot, Devon (GB)

Correspondence Address: FLESHNER & KIM, LLP, P.O. Box 221200, Chantilly, VA, 20153-1200, US

(21) Appl. No.: 09/755,297

(22) Filed: Dec. 28, 2000

(30) Foreign Application Priority Data
Oct. 6, 2000 (GB) 0024477.2

(51) Int. Cl. G02B 6/42; G02B 6/12

(52) U.S. Cl. 385/92; 385/14

(57) ABSTRACT

An integrated optical package comprises an integrated optical device within a casing, an optical fiber coupled with the device and following a curved path, the fiber being supported by a substantially rigid conduit at least between an interior wall of the casing and the coupling with the optical device. This relieves stress which would otherwise be exerted by the fiber. It is preferred that the conduit has a C-section thereby to support the fiber therewithin. Alternatively, the conduit can comprise two fitting parts which when fitted together form a closed conduit such as an annular section. The conduit can be molded of a plastics material. The conduit can be snug with the fiber and hence supported thereby.

The present invention relates to the packaging of integrated optical devices.

Integrated optical packages comprise a device to and from which light signals are conveyed via optical fibres, which are usually clad. The fibres are typically attached to the device via a fibre block, and pass through an external casing of the package via a grommet or the like. The fibre block is intended to provide an interface between the fibre and the device to optimise coupling, and usually meets the device at an angle in order to minimise reflection losses at the interface, whereas the fibre can meet the fibre block substantially linearly. Thus, the fibre tends to approach the device at an angle to the plane of the device, the angle of the fibre block. However, to fit in a confined space together with other devices it is normal for the fibre to leave the casing horizontally, parallel to the plane of the device, so the fibre often follows a curved path such as an S-bend within the casing. A vertical or horizontal offset between the device and the grommet where the fibre leaves the casing will also require an S-bend, in one or more planes.

This curved path results in a stress state existing within the fibre which is kept in equilibrium by a tension exerted by the fibre on the fibre block. This can act so as to separate the fibre block from the active device and is therefore a factor in the long term reliability of the package as a whole. Accordingly, the present invention seeks to alleviate this.

It will be appreciated that the invention is not limited to devices or packages incorporating a fibre block, as there are other means of attaching fibres to active devices and similar considerations will arise.

The present invention therefore provides an integrated optical package comprising an integrated optical device within a casing, an optical fibre coupled with the device and following a curved path within the casing, the fibre being supported by a rigid conduit at least between an interior wall of the casing and the coupling with the optical device.

It is preferred that the conduit has a C-section thereby to support the fibre therewithin. Alternatively, the conduit can comprise two fitting parts which when fitted together form a substantially closed conduit such as an annular section. The conduit can be moulded of a plastics material, preferably a rigid or structural polymer. Polymers such as polybutylene terephthalate polyester (PBF-P) or polyphenylene sulfide (PPS) are suitable, preferably with a 40-60% glass fibre reinforcement.

The weight of the conduit can be borne by the fibre, particularly if it is a snug fit. The purpose of the conduit is to dissipate the flexural stresses in the fibre resulting from the S-bend along the length of the conduit, instead of allowing them to concentrate at the point of coupling with the device.

A single conduit can if desired be arranged so as to support a plurality of fibres or a ribbon cable.

The present invention also relates to a curved support conduit for a fibre between a casing and an integrated optical device.

Embodiments of the present invention will now be described by way of example, with reference to the accompanying figures, in which;

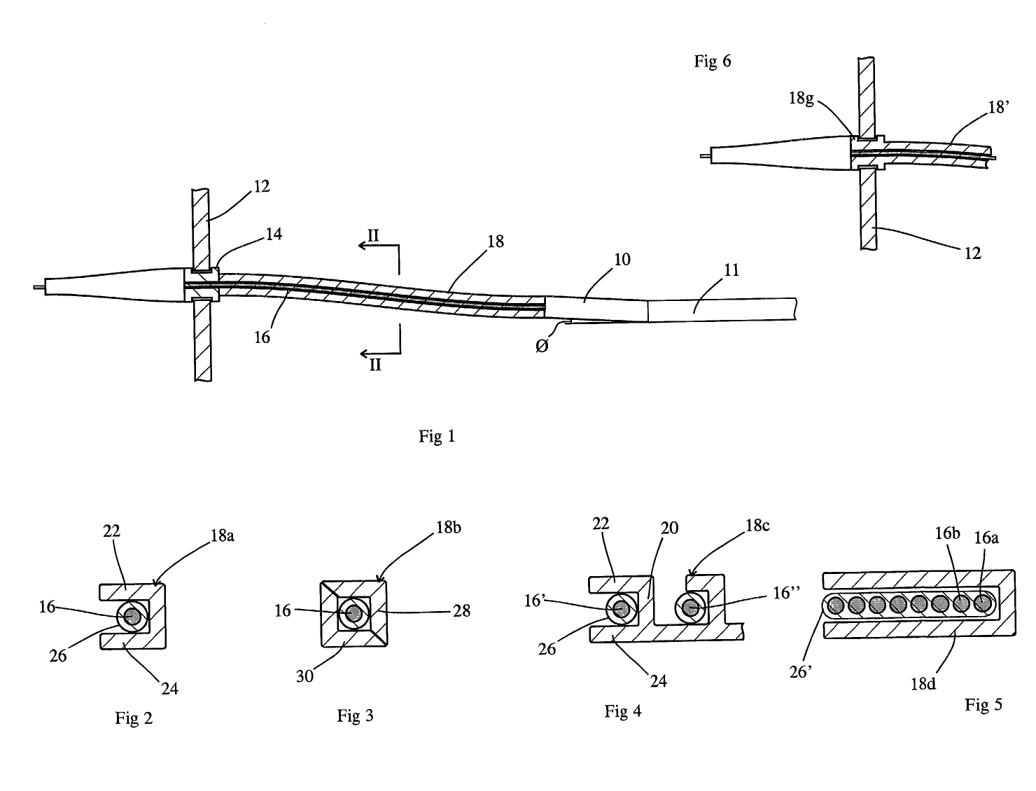

FIG. 1 is a vertical section through a first embodiment of the present invention;

FIG. 2 is a section on II-II of FIG. 1;

FIG. 3 is a like section of a second embodiment of the invention;

FIG. 4 is a like section of a third embodiment of the invention;

FIG. 5 shows a fourth embodiment for ribbon fibre, and

FIG. 6 shows a fifth embodiment.

Referring to FIG. 1, a fibre block 10 is disposed at an angle φ to the plane of the device in order to mate with the integrated optical device 11 with minimum reflective losses. The block 10 and the device are contained within a package which includes a side wall 12 in which is provided a grommet 14 for a clad fibre 16 to pass through and connect to the fibre block 10.

The fibre 16 therefore passes through a gentle S-bend from the block 10 to the wall 12. In this region, it is supported by a conduit 18 which is moulded of a rigid polymer into the design profile of the S-bend. Thus, the conduit is pre-formed to the desired shape. The conduit can be of a variety of suitable forms, as shown in FIGS. 2 and 3. Suitable polymers are polybutylene terephthalate polyester (PBF-P) or polyphenylene sulfide (PPS), preferably with a 40-60% glass fibre reinforcement.

FIG. 2 shows a first embodiment of the conduit 18a. In section, there is a side wall 20, from the longitudinal edges of which extend a top wall 22 and a bottom wall 24. This therefore forms a C-section in which the fibre 16 is located. The cladding layer 26 which is typically of a resilient plastics material protects the fibre 16 from damage by the conduit 18a. The open side of the C-section is directed transverse to the plane of the S-bend and therefore there is no tendency for the fibre to leave to conduit.

FIG. 2 shows a second embodiment of the conduit 18b. Two mating sides 28, 30 are each of a perpendicular V-section and, when mated, thereby form a closed square section conduit 18b. The fibre 16 is inserted prior to mating. The two sides can be mated by adhesive, or by mechanical snap fittings such as are known in the art, or by an external binding, or the like.

FIG. 4 shows a third embodiment, suitable for use in supporting a plurality of fibres leading to a plurality of nearby locations. In this case the conduit 18c is similar to the conduit 18a of FIG. 2, but is duplicated a plurality of times, each further C-section recess extending from the side wall 20. Fibres 16′ and 16″ etc lie in each C-section, although it is not essential that all be occupied. An alternative arrangement, for example a clamshell, could be provided to cater for ribbon cables.

FIG. 5 shows a fourth embodiment specifically for use in supporting ribbon cable, which comprises a plurality of optical fibres 16a, 16b etc encapsulated in a single cladding 26′. The conduit 18d is extended to accommodate the greater width of the ribbon cable but is otherwise similar to the embodiment of FIG. 2.

FIG. 6 shows a fifth embodiment of the invention which is generally similar to the embodiment of FIG. 1, except that the conduit 18′ has an integrated grommet 18g for carrying the fibre through the wall 12. This will speed assembly and align the conduit with the package in a secure fashion.

Other forms for the conduit are possible. For example, the second embodiment could employ semicircular section halves which when mated form a circular section annular conduit.

1. An integrated optical package comprising;
an integrated optical device within a casing;
an optical fibre being coupled with the device and following a curved path;
the fibre being supported by a substantially rigid conduit at least between an interior wall of the casing and the optical device.

2. An integrated optical device according to claim 1 in which the conduit has a C-section thereby to support the fibre therewithin.

3. An integrated optical device according to claim 1 in which the conduit comprises two fitting parts forming a substantially closed conduit

4. An integrated optical device according to claim 3 in which the two fitting parts form an annular section.

5. An integrated optical device according to any preceding claim in which the conduit is moulded of a plastics material.

6. An integrated optical device according to claim 5 in which the plastics material is one of polybutylene terephthalate polyester, polyphenylene sulfide, glass fibre reinforced polybutylene terephthalate polyester, and glass fibre reinforced polyphenylene sulfide.

7. An integrated optical device according to any preceding claim in which the fibre is attached to the device via a fibre block.

8. An integrated optical device according to any preceding claim in which the weight of the conduit is supported by the fibre.

9. An integrated optical device according to any preceding claim in which a plurality of optical fibres are supported by the conduit.

10. An integrated optical device according to any preceding claim in which the fibre is clad.

11. An integrated optical device according to any preceding claim in which the conduit has a grommet formed integrally at on end for passage through the interior wall.

12. A curved support conduit for an optical fibre between a casing and an integrated optical device.

13. A curved support conduit according to claim 12 for supporting a plurality of optical fibres.

14. A curved support conduit for an optical fibre according to claim 12 or claim 13 including a grommet integrated at one end thereof.

15. An integrated optical device substantially as herein described with reference to and/or as illustrated in the accompanying drawings.

16. A curved support conduit for an optical fibre substantially as herein described with reference to and/or as illustrated in the accompanying drawings.
